(19) United States
(12) Patent Application Publication
(10) Pub. No.: US 2008/0196358 A1
(43) Pub. Date: Aug. 21, 2008

(54) System and Assembly for Sealing Containers

(75) Inventor: Helene Schafer-Roth, Holmdel, NJ (US)

Correspondence Address: DeMont & Breyer, LLC, 100 Commons Way, Ste. 250, Holmdel, NJ, 07733, US

(73) Assignee: Holger Schwedler, 65195 Wiesbaden (DE)

(21) Appl. No.: 11/568,759

(22) PCT Filed: May 11, 2005
(86) PCT No.: PCT/EP05/05083

§ 371 Date: Apr. 24, 2008

(30) Foreign Application Priority Data
May 11, 2004 (DE) 20 2004 007 718.3

(51) Int. Cl. B67B 1/04; B67B 1/03; B65B 57/02

(52) U.S. Cl. 53/67; 53/319; 53/290; 53/167

(57) ABSTRACT

The invention is based on the objective of disclosing a method for sealing containers, particularly bottles, in a mechanized fashion by means of rigid closures, particularly rigid glass stoppers that require careful handling.

To this end, an assembly (110) is provided that is designed for sealing containers (20), particularly bottles, by means of rigid closures (10) that are adapted to the containers (20), particularly glass stoppers. The assembly comprises a controllable ram (180, 190) for joining the at least one container (20) and the at least one rigid closure (10), as well as a holding device (300) for holding the at least one rigid closure (10), wherein the holding device (300) has a shape that is at least partially adapted to the shape of the least one rigid closure (10) in order to hold the rigid closure (10) in a predetermined position.

The invention pertains to systems for sealing containers, particularly with closures that are adapted to the containers, as well as to assemblies for use in such systems.

Various types of closures are used for sealing beverage containers, for example, screw caps, crown caps, natural corks or even plastic corks. Natural corks have been the closure of choice for quite some time, particularly with respect to wine bottles. Alternative closure systems such as screw caps or plastic corks have not established themselves in this field so far.

Methods and devices for mechanically sealing wine bottles with natural corks are known, for example, from DE 44 05 007 C1 or DE 37 36 588 A1. The devices described in these publications feature so-called cork locks for compressing the flexible natural corks to a cross section that corresponds to the bottle opening. The insertion of the cork into the bottle is realized by ejecting the cork from the cork lock with such high speed that the flexible cork is unable to expand back into its normal shape.

A rigid glass stopper is a new alternative type of closure, particularly for sealing wine bottles. A glass stopper of this type is marketed, for example, by Alcoa Germany GmbH under the trade name “Vino-Lok.” Wine bottles sealed with such a glass stopper are already available for sale. The problem with this closure system can be seen in that this is a novel application for glass. Due to its fragility, it needs to be handled particularly carefully.

This is the reason why bottles had to be manually sealed with glass stoppers until now. No attempts are currently being made to develop a device for the mechanized sealing of containers with rigid glass stoppers.

Consequently, the invention is based on the objective of disclosing a method for sealing containers, particularly bottles, in a mechanized fashion with rigid types of closures, particularly rigid glass stoppers that require careful handling.

This objective is attained with an assembly for sealing containers according to Claim 1, as well as with a system for sealing containers according to Claim 25. Advantageous embodiments and additional refinements are described in the respective dependent claims.

Accordingly, an inventive assembly for sealing containers with rigid closures that are adapted to the container comprises at least one controllable ram for joining the at least one container and the at least one rigid closure, as well as a holding device for holding the at least one rigid closure, wherein the holding device has a shape that is at least partially adapted to the shape of the at least one rigid closure so as to hold the rigid closure in a predetermined position.

The at least one rigid closure is advantageously guided at least sectionally by the holding device while it is joined with the container.

This assembly can be utilized in a particularly advantageous fashion for sealing bottles, particularly glass bottles, with rigid glass stoppers. The glass stopper for sealing bottles preferably has a shape composed of an upper cylindrical region that is also referred to below as the head and an adjacent region in the shape of a truncated cone, wherein the region with the shape of a truncated cone is inserted into the bottle opening and the cylindrical region rests on the bottle neck. In order to reliably seal a bottle with a thusly shaped rigid glass stopper, the adjoining glass surfaces of the glass stopper and the bottle can be ground accordingly. However, the glass stopper may alternatively or additionally feature a ring seal because it is very costly to produce these ground glass surfaces.

The rigid glass stopper is protected from damage, in particular, by the specially shaped holding device. The containers to be sealed with the inventive assembly do not have to consist of bottles. It is also possible to process differently shaped containers with one or more openings. The containers may also consist of different materials such as, for example, glass, plastic or any other suitable material.

It is particularly advantageous that the holding device feature at least one clamping arm, wherein two clamping arms are preferably utilized. The clamping arms may either be realized in the form of stationary or movable holding arms, wherein at least one clamping arm needs to be arranged in a movable fashion in order to clamp the stopper. Consequently, at least one first movable holding arm is prestressed relative to at least one second stationary or movable holding arm by means of a suitable clamping device. The utilization of clamping arms makes it possible to adapt the force acting upon the rigid closure such that damage is prevented.

Accordingly, the holding device advantageously features at least one clamping device for clamping the at least one clamping arm. The clamping device may be realized mechanically, electrically and/or pneumatically. It is particularly preferred to utilize a mechanical tension spring for this purpose because such a clamping device represents the least expensive solution.

The holding device advantageously features at least one guide element, on which the at least one clamping arm is fixed in order to move the rigid closure into the intended holding position in a controlled fashion.

In order to hold rigid closures with an at least partially cylindrical shape, it is particularly advantageous to realize at least a partial area on the inner side of the at least one clamping arm in a rounded fashion.

In one particularly advantageous embodiment, the holding device comprises at least a first and a second guide element, between which the at least one rigid closure is horizontally guided, a first and a second clamping arm that are respectively arranged in a movable fashion on the first and second guide element, and a clamping device for prestressing the first and the second clamping arm relative to one another.

In one preferred embodiment, the at least one clamping arm furthermore features at least one supporting surface, on which the at least one closure lies while it is held by the holding device. The supporting surface may be simply realized in the form of a plate that is fixed on the at least one clamping arm.

It is advantageous that the supporting surface be essentially arranged horizontally in order to prevent the rigid closure from moving downward, for example, under the influence of its own weight. Once the rigid closure should be moved downward in order to be joined with the container, it is necessary to displace the at least one clamping arm in order to release the rigid closure. Accordingly, the ram is advantageously realized such that the at least one clamping arm is displaced by the ram while the at least one container and the at least one rigid closure are joined.

In order to displace two clamping arms that adjoin one another with their respective end faces in the prestressed state, the end faces are advantageously beveled on at least one edge. The ram preferably features a corresponding laterally arranged actuating element that is realized in a wedge-shaped fashion on its lower end and engages on the beveled edges of the clamping arms while the ram is lowered and thusly displaces the clamping arms out of the prestressed starting position. The wedge-shaped actuating element is preferably arranged on the ram in such a way that the clamping arms are uniformly displaced and the container opening remains in a centered position relative to the clamping arms.

A possible rotation of the ram may be problematic in this case because this can change the position of the wedge-shaped guide element for displacing the clamping arms. Consequently, the assembly advantageously features a guide rail for guiding the ram. The guide rail is at least partially adapted to the shape of the ram. To this end, the cross section of the ram perpendicular to its moving direction is essentially realized with a polygonal shape.

It is also advantageous to guide the rigid closure with the ram while it is joined with the container. To this end, the end face of the ram advantageously features at least three centering tabs for positioning and fixing the at least one rigid closure. For example, the centering tabs are centrally milled out of the end face of the ram that has a rectangular or preferably square cross section with a round milling cutter. The centering tabs prevent the closure from sliding away laterally and center the closure relative to the ram axis and therefore relative to the container opening.

The part of the end face of the ram that presses on the rigid closure is preferably profiled. This can serve, for example, for protecting decorative details arranged on the upper side of the closure such as, for example, the crest of the wine grower when the wine bottle is sealed. In this case, the profile of the ram is realized, in particular, complementary to the end face of the at least one rigid closure. However, the profile may also serve, for example, for pressing a decorative detail into a depression on the upper side of the closure.

In a further preferred embodiment, the holding device is at least partially realized in a funnel-shaped fashion. When a rigid closure is supplied to a thusly designed holding device, its own weight and the adapted shape of the closure and the funnel-shaped holding device cause the rigid closure to assume and be held in a predetermined position. In order to move the closure downward by means of the ram, the holding device of this embodiment is advantageously realized in an at least sectionally elastic fashion.

When a container is sealed with a rigid glass stopper, in particular, it is necessary to align the container opening with the glass stopper before they are joined. Consequently, the assembly preferably features at least one positioning device for fixing the container. It is also possible to provide several positioning devices. A bottle can be fixed, for example, by respectively arranging one device at the height of the body of the bottle and one at the height of the bottle neck.

It is particularly advantageous to realize the positioning device in such a way that a container is fixed during the continuous operation of the supply device, for example, a conveyor belt.

In order to detect the container and therefore the exact actuating time of the positioning device, the positioning device advantageously features at least one optical sensor and/or a mechanical roller switch with lever flag.

The positioning device advantageously features a controllable pressing element for being pressed against an abutment so as to fix the container in a particularly stable fashion.

It is particularly preferred that the positioning device feature two controllable grippers that are moved toward one another in order to fix the container. The sides of the grippers that engage on the container preferably feature a trapezoidal or wedge-shaped recess. Two grippers of this type are particularly suitable for fixing a bottle in the region of the bottle neck.

The objective of the invention is also attained with a system for sealing containers according to Claim 25. Accordingly, an inventive system comprises at least one assembly of the above-described type, as well as a device for supplying at least one container and a device for supplying at least one rigid closure.

In order to seal several containers simultaneously, the system may advantageously comprise several above-described assemblies that are preferably arranged in succession along the transport direction of the container.

In order to supply the closures to the holding device in the correct position, the device for supplying at least one closure advantageously features a workpiece supply device for supplying rigid closures in the correct position. Conventional workpiece supply devices or automatic organizers may be utilized for this purpose and may be provided, for example, with a swing feeder or a slide valve, particularly a rotary slide valve. The workpiece supply device may also be advantageously realized in the form of a linear conveyor. The workpiece supply device is suitable for supplying a plurality of identical rigid closures in an essentially constant position or orientation, respectively.

With respect to the supply of rigid glass stoppers with the above-described shape, it is advantageous to transport the glass stoppers on the workpiece supply device with the head pointing downward, namely because this stabilizes the glass stoppers due to the lowered center of gravity. Since the glass stopper needs to have the opposite orientation for insertion into an upright container with an opening on its upper side, the system advantageously features a supply baffle for transferring the at least one rigid closure from a first orientation to a second orientation.

In order to transport the at least one rigid closure to the holding device, the system advantageously features a supply rail with an at least partial downward slope in the direction of the holding device. The downward slope extends at an angle between 30° and 60° referred to the horizontal line, preferably between 40° and 50°, particularly 45°. The slope of the supply rail is particularly advantageous because the at least one rigid closure can be transported to the holding device under the influence of its own weight and an active transport device is not required.

When sealing containers with rigid closures, particularly glass stoppers, it may be required to disinfect the closures before the containers are sealed. Accordingly, the system preferably features a disinfecting device for disinfecting the at least one rigid closure. The disinfecting device may be realized, for example, in the form of a chamber with a supply line and a discharge line for a liquid disinfectant, for example, a mist or a gas. The rigid closures are preferably conveyed through this disinfection chamber while they are supplied to the holding device.

In order to protect the rigid closures from damage and/or to ensure a smoothly running transport of the rigid closures, at least a partial area of one surface of a workpiece supply device and/or a supply baffle and/or a supply rail and/or a guide element and/or a clamping arm and/or a ram is provided with a coating, particularly a protective coating.

The scope of the invention also includes a method for sealing containers, particularly bottles, by means of rigid closures that are adapted to the containers, particularly glass stoppers, wherein said method comprises the following steps:
holding the at least one rigid closure by means of a holding device, the shape of which is at least partially adapted to the shape of the at least one rigid closure, and
joining the at least one container and the at least one rigid closure by means of a controllable ram.

The method preferably also comprises the step of supplying at least one container and/or supplying at least one rigid closure.

The method furthermore comprises the advantageous step of at least sectionally guiding the at least one rigid closure by means of the holding device and/or the ram.

The holding device advantageously features at least one clamping arm. In this case, the method advantageously comprises the step of clamping and/or prestressing the at least one clamping arm by means of a clamping device, wherein the clamping device is preferably realized mechanically, electrically and/or pneumatically.

It is particularly advantageous that the method comprise the step of opening the clamping arms by means of the ram while the at least one container and the at least one rigid closure are joined. The method preferably also comprises the step of centering the clamping arms relative to the position of the container opening.

The method preferably also comprises the step of guiding the ram in a guide rail that is adapted to the shape of the ram. The method preferably also comprises the step of positioning and fixing the at least one rigid closure by means of at least three centering tabs arranged on the end face of the ram.

The method advantageously comprises the additional step of fixing a container by means of the at least one positioning device, particularly during the continuous operation of the device for supplying the containers. To this end, the method preferably comprises the step of detecting a container with the aid of an optical sensor and/or a mechanical switch, particularly a roller switch with lever flag.

It is particularly advantageous that the method comprise the step of taking hold of a container, particularly a bottle, in the region of the bottle neck by means of two grippers that move in opposite directions. The side of the grippers that engages on the container preferably contains a trapezoidal or wedge-shaped recess in this case.

The supply of at least one rigid closure advantageously comprises the correctly positioned supply of rigid closures by means of a workpiece supply device. Furthermore, the method advantageously comprises the step of transferring the at least one rigid closure from a first orientation to a second orientation, particularly by means of a supply baffle.

In one particularly advantageous variation, the method comprises the step of supplying the at least one rigid closure by means of a supply rail with an at least partial downward slope in the direction of the holding device, wherein the downward slope extends at an angle between 30° and 60° referred to the horizontal line, preferably between 40° and 50°, particularly 45°.

In addition, the method may comprise the advantageous step of disinfecting the at least one rigid closure with a liquid disinfectant during the supply of the at least one rigid closure.

Preferred embodiments of the invention are described in greater detail below with reference to the enclosed figures. In this case, identical or similar components are identified by the same reference symbols in the figures.

Shown are:

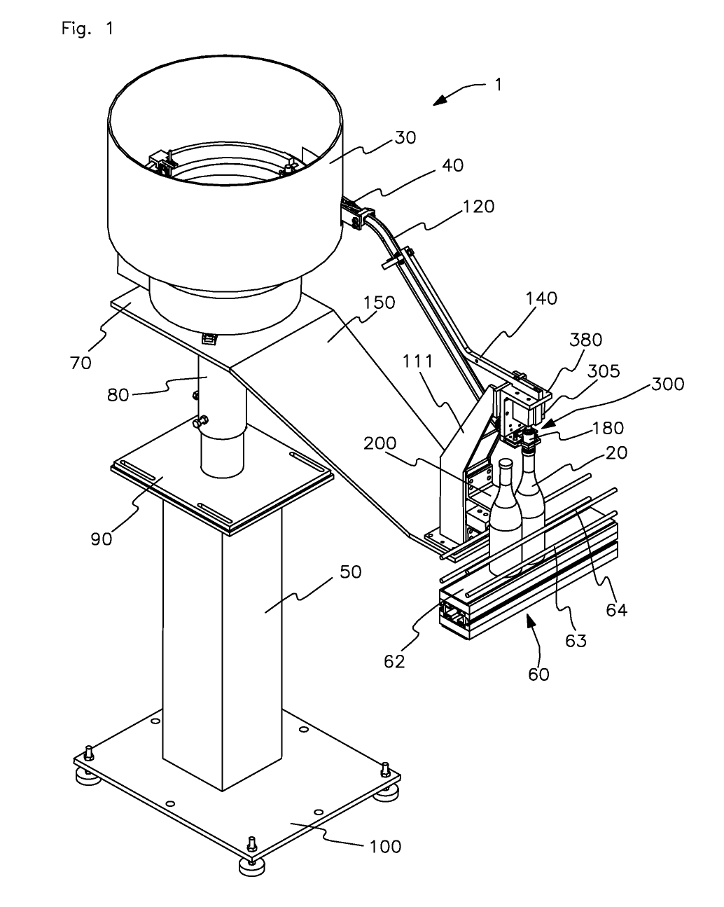

FIG. 1, a schematic representation of one embodiment of an inventive system;

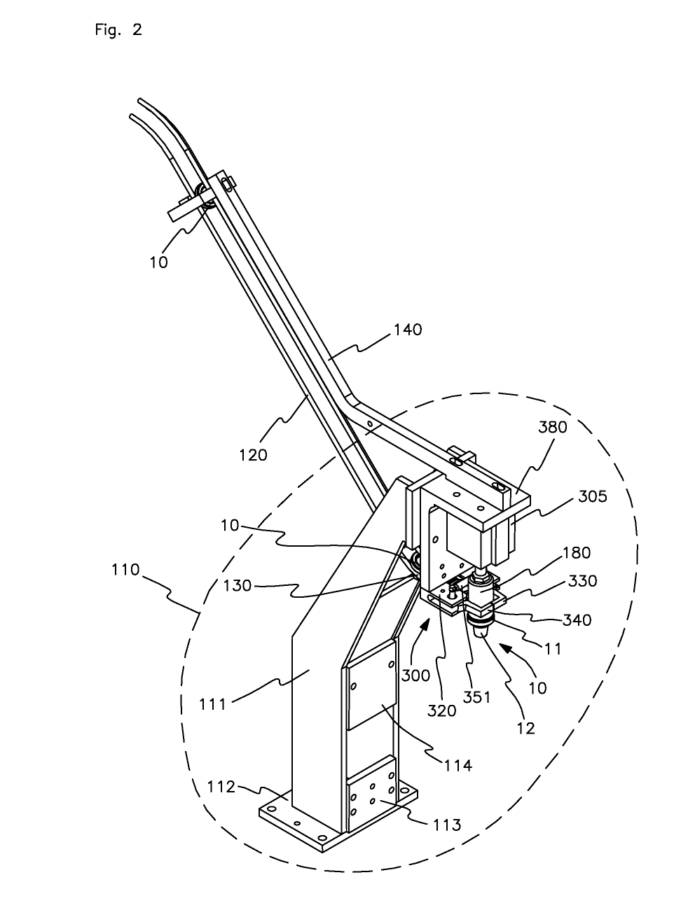

FIG. 2, a schematic representation of individual components of the system according to FIG. 1;

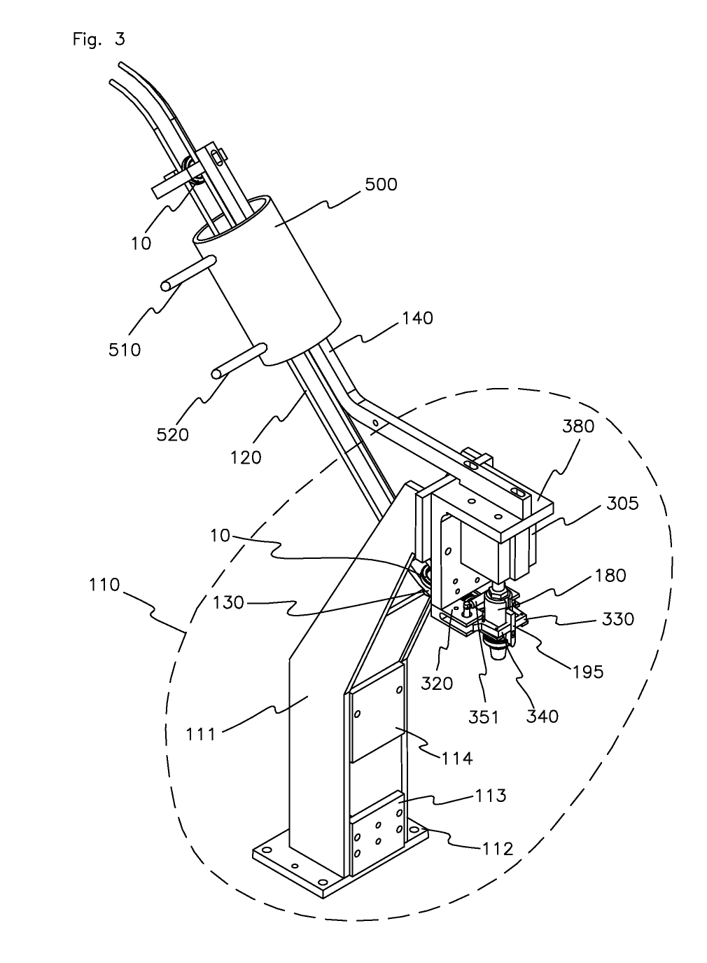

FIG. 3, a schematic representation of components of another embodiment of an inventive system;

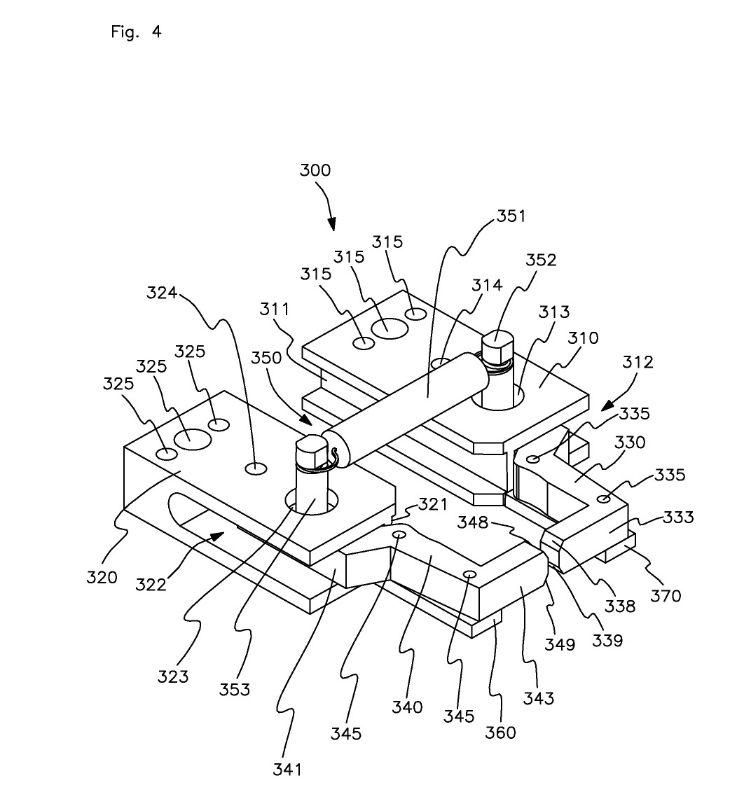

FIG. 4, a schematic representation of a holding device;

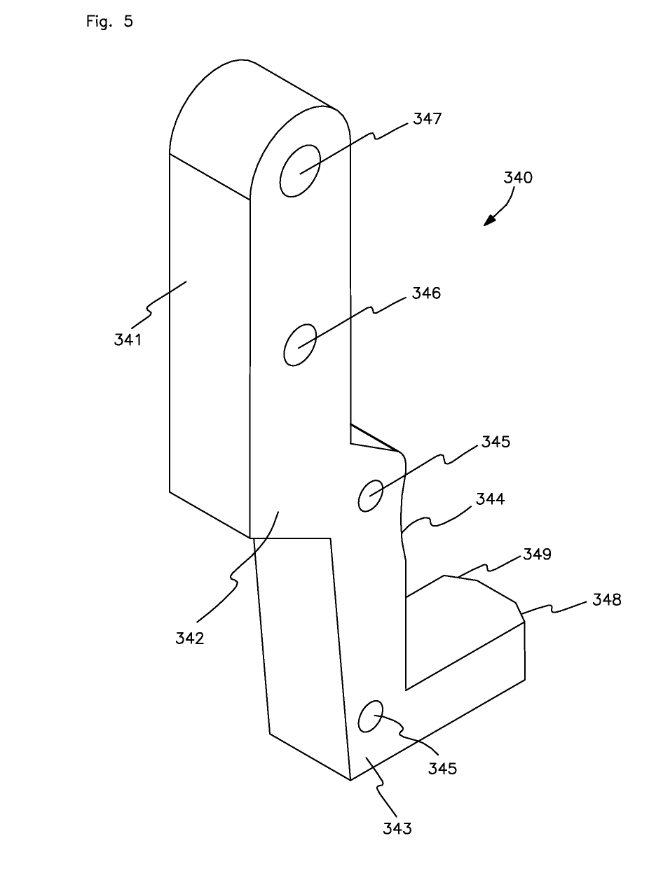

FIG. 5, a schematic representation of a clamping arm;

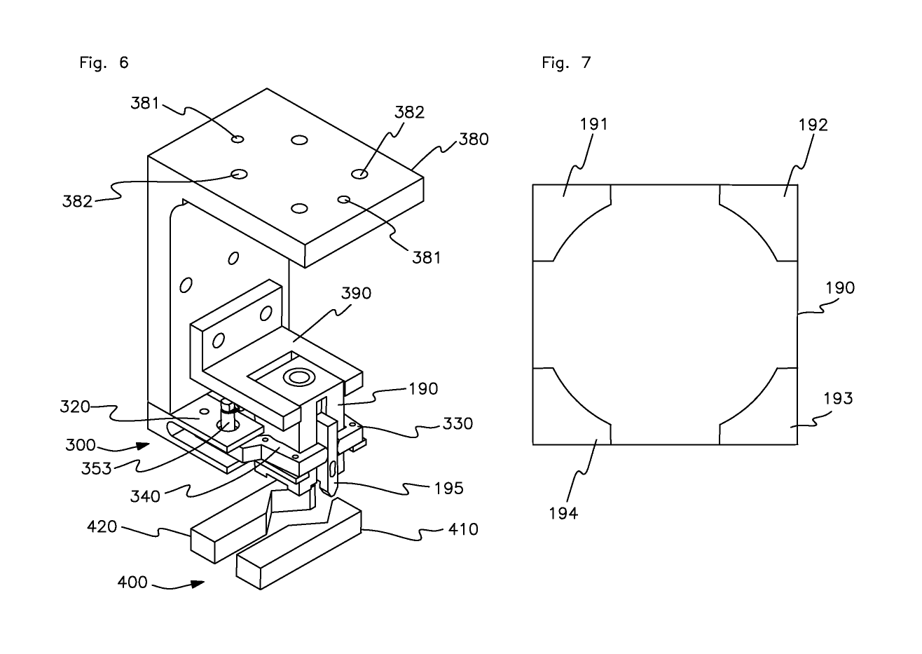

FIG. 6, a schematic representation of an inventive assembly with a ram, a holding device and a positioning device;

FIG. 7, a schematic horizontal projection of the end face of a ram with centering tabs;

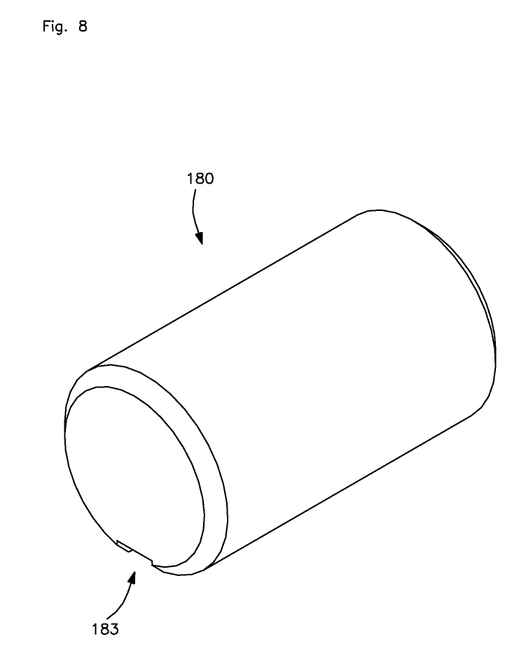

FIG. 8, a schematic representation of a ram with circular cross section;

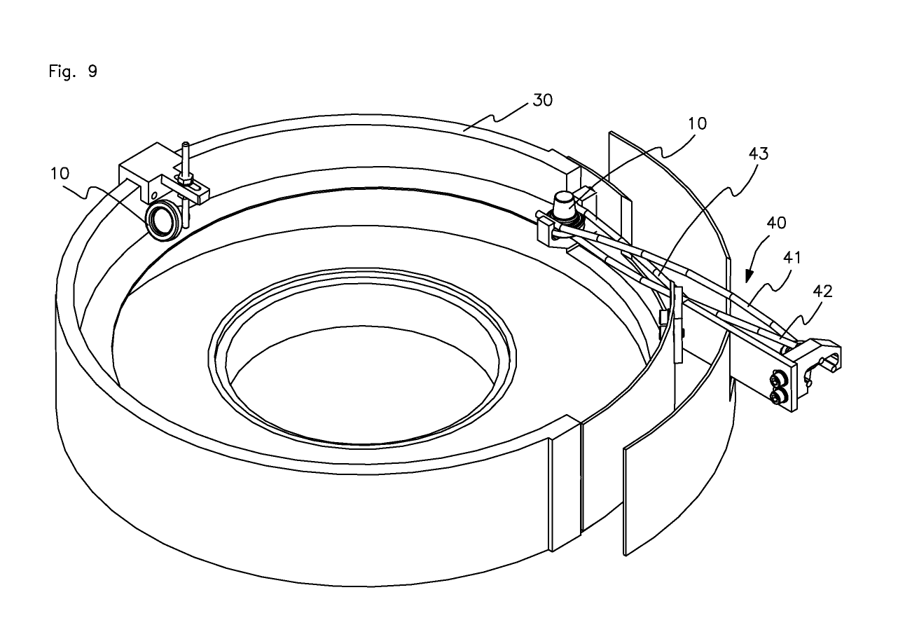

FIG. 9, a schematic representation of a workpiece supply device for supplying closures by means of a supply baffle;

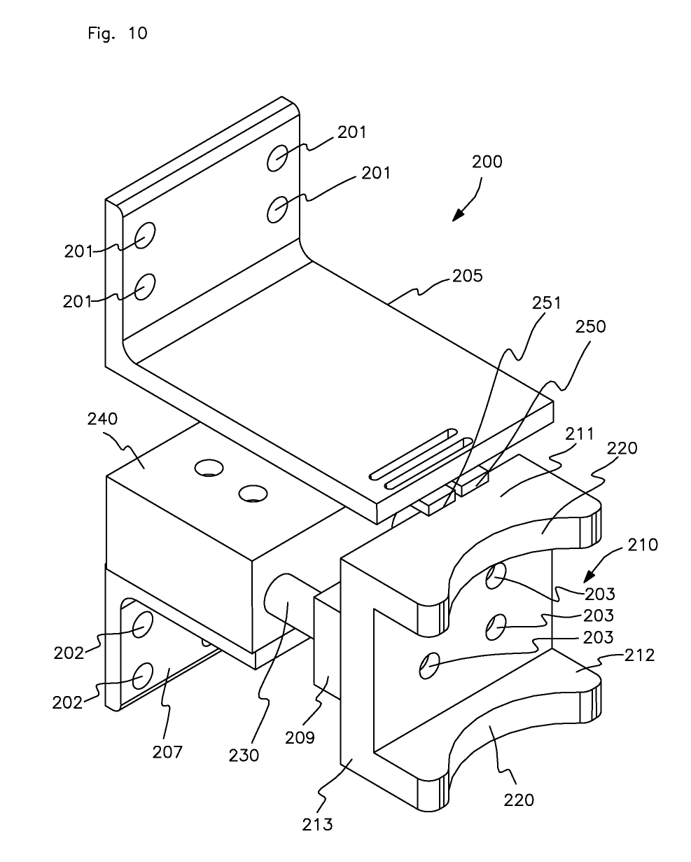

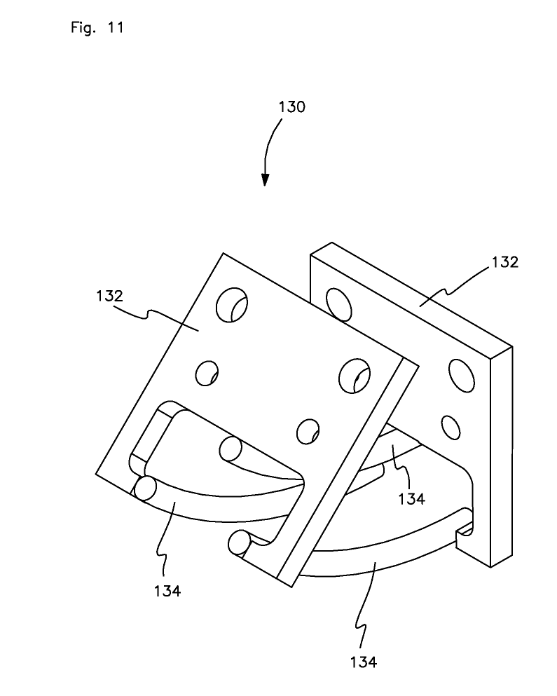

FIG. 10, a schematic representation of a positioning device for fixing a container, and

FIG. 11, a schematic representation of part of the supply rail for supplying the rigid closures.

FIG. 1 shows an exemplary system that is identified by the reference symbol 1 and serves for automatically sealing bottles 20, preferably with a glass stopper 10. The system 1 features a glass stopper supply device 30 that is illustrated in detail in FIG. 9 and features, for example, a circular receptacle with a helically extending track arranged therein. A supply baffle 40 arranged at the end of the helical track ensures that the glass stoppers 10 are transferred from a first orientation to a second orientation. To this end, the supply baffle 40 features three rails 41, 42 and 43 that are rotationally offset relative to one another and turn the respective glass stopper 10 by 180°. The glass stopper supply device 30 may feature a swing feeder or a slide valve, particularly a rotary slide valve, for delivering the glass stoppers 10 to the supply baffle 40.

The description now returns to FIG. 1. The glass stopper supply device 30 is seated on an upper platform 70 that is mounted on another platform 90 by means of a height-adjustable lifting device 80. The lifting device 80 may feature tubes that can be telescopically extended and retracted. The middle platform 90 is mounted on a bottom plate 100 by means of a rectangular tube 50. The upper platform or support plate 70 is connected to a supporting device 111 of an assembly identified by the reference symbol 110 by means of a connecting plate 150 with a downward slope toward the platform 70. The assembly 110 is illustrated in detail in FIG. 3. Due to this construction, the glass stopper supply device 30 can be vertically moved relative to a sectionally illustrated bottle supply device 60 together with the assembly 110. The supply device 60 features a conveyor belt 62 and, for example, two guide rails 63 and 64 for laterally holding and guiding bottles 20 to be sealed.

A connecting element 130 fixed on the supporting device 111 is indicated in FIGS. 2 and 3 and illustrated in greater detail in FIG. 11. The connecting element 130 features two flange elements or connecting plates 132 that are angled relative to one another and connected by means of three rail sections 134. The three rail sections 134 are aligned with three rail sections of a supply rail 120. The supply rail 120 is screwed to the supply baffle 40 and to one of the connecting plates 132. The supply rail 120 preferably extends downward from the glass stopper supply device 30 to the assembly 110 at an angle of 45°.

A holding and positioning device 200 mounted on the supporting device 111 is able to also hold a bottle 20 to be sealed during the continuous operation of the supply device 60 in this case. A not-shown stationary fitting may be provided on the supply device 60 for this purpose.

The holding and positioning device 200 is illustrated in greater detail in FIG. 10. In an exemplary embodiment, the holding and positioning device 200 features two L-shaped mounting plates 205 and 207 that can be mounted on the supporting device 111 by means of screws extending through bores 201 and 202. Furthermore, a holding and positioning element 210 is provided and features two profiled holding arms 211, 212 arranged on top of one another. The concave recesses 220 in the holding arms 211 and 212 are adapted to the shape of the bottles 20 to be held. In order to take hold of differently shaped bottles, the material of the holding arms 211 and 212 may be elastic. In this example, the two holding arms 211 and 212 are connected to one another by a base plate 213 that can also be fixed on a holding plate 209 by means of screws extending through bores 203. The holding plate 209 is connected to a lifting device 240 that may be realized in the form of a lifting cylinder by means of pistons 230. The lifting device 240 moves the holding and positioning element 210 in the direction of the supply device 60 and back again. Optical sensors 250 and 251 can be used for detecting whether a bottle to be sealed has arrived in the holding region of the holding and positioning device 200. Alternatively, the optical sensors can be replaced with a not-shown roller switch that is actuated by a lever flag that detects the arriving bottles 20.

An angled, L-shaped holding element 380 is illustrated in greater detail in FIG. 6 and is also mounted on the supporting device 111 according to FIG. 1. A lifting cylinder 305 is screwed to the horizontal section of the holding element 380 as shown in FIG. 1. Bores 382 are provided in the horizontal section for this purpose. The vertical section of the holding element 380 is mounted on the supporting device 111. A glass stopper holding device 300 mounted on the lower end of the vertical section is illustrated in greater detail in FIG. 4. The mounting can be realized with the aid of bores 315 in a first guiding and holding element 310 and bores 325 in the second guiding and holding element 310. According to FIG. 1, a ram 180 is connected to the lifting cylinder 305 by means of a piston rod. The ram 180 may have the shape of a circular cylinder as illustrated in FIG. 8. A longitudinal groove 183 extending on the lateral periphery of the ram 180 serves for receiving an actuating element 195 as shown in FIG. 3. A disk-shaped projection may be integrally formed onto an end face that points to the bottle 20 to be sealed, wherein said projection is able to penetrate into a corresponding recess in a glass stopper in order to guide the glass stopper during the sealing of the bottle.

In addition, a holding clip 140 is screwed to the supply rail 120 and to the horizontal section of the L-shaped holding element 380. Bores 381 are provided for this purpose. In FIGS. 2 and 3, the assembly 110 is illustrated with the supply rail 120 mounted thereon, namely in the form of an enlarged detail as compared to FIG. 1. FIG. 3 can be distinguished from FIG. 2 in that the supply rail 120 sectionally extends through a disinfection chamber 500. A disinfectant is introduced into the disinfection chamber 500 in liquid or gaseous form via a supply line 510. A tank for the disinfectant is not shown in the figures. A service line 520 that can be connected to a not-shown suction device is provided for removing the used disinfectant. A ram 180 with an inserted actuating element 195 is illustrated in the extended state, in which the actuating element 195 presses apart the clamping arms 330 and 340. The supporting device shown in FIGS. 2 and 3 features a base plate 112 that can be mounted on the connecting plate 150. The L-shaped support plate 207 or 205 of the holding and positioning device 200 can be mounted on holding plates 113 and 114 of the supporting device 111.

The following portion of the description once again refers to FIG. 6. A guide element 390 is mounted on the vertical section of the L-shape holding element 380 above the glass stopper holding device 300. The guide element contains a square recess that corresponds to the cross section of the rectangular ram 190. The rectangular ram 190 is guided in the guide element 390 over the entire lifting distance. This prevents the ram 190 from turning or tilting. The rectangular ram 190 shown in FIG. 6 features an actuating element 195. The actuating element 195 has two functions: first, the clamping arms 330 and 340 are pressed apart in order to release a clamped glass stopper 10 during the sealing of a bottle 20. The second function of the actuating element 195 consists of holding the clamping arms 330 and 340 in a stable position. This is achieved in that the actuating element 195 is held between the sloped guide surfaces 348 and 338 of the clamping arms 340 and 330 in the retracted state of the ram 190. According to FIG. 6, the actuating element 195 features a wedge-shaped point, the dimensions of which essentially correspond to the recess created when the clamping arms 330 and 340 are pressed against one another. The end face of the rectangular ram 190 that points to the bottle preferably features four centering tabs 191, 192, 193 and 194 that are illustrated in FIG. 6 in combination with FIG. 7. The inner surface of the tabs corresponds to a circular surface such that a circular glass stopper 10 is guided therebetween. Another holding device 400 for taking hold of the bottle neck of a bottle 20 to be sealed is arranged underneath the glass stopper holding device 300. The holding device 400 features two opposite holding arms 410 and 420 that are supported in a movable fashion. For example, the holding arms 410 and 420 are connected to a (not-shown) lifting cylinder mounted on the supporting device 111. The holding arms 410 and 420 feature, for example, wedge-shaped or trapezoidal recesses in order to hold bottle necks with different diameters.

The following portion of the description pertains to the glass stopper holding device 300 shown in FIG. 4. Two guiding and holding elements 310 and 320 are provided for receiving the clamping arms 330 and 340, respectively. To this end, the guiding and holding element 310 features a receiving and turning chamber 312 and the guiding and holding element 320 features a receiving and turning chamber 322. The clamping arm 340 is illustrated in greater detail in FIG. 5. It should be noted that the clamping arm 330 is realized in a mirror-symmetric fashion referred to the clamping arm 340. The clamping arm 340 has an elongated limb 341 that is connected to an angled holding arm 343 by means of a web 342 that preferably extends obliquely inward. The angled holding arm 343 has an inwardly directed section, the end face of which features beveled guide surfaces 348 and 349. Bores 345 serve for screwing on a supporting plate 360 according to FIG. 4 by means of screws. A retaining bolt 353 can be inserted into a bore 346 as shown in FIG. 4. A pivot pin for rotatably supporting the clamping arm 340 in guiding and holding element 320 can be inserted into the bore 347. At least part of the inner surface of the angled holding arm 343 has a rounded surface 344 for holding a glass stopper 10 with round cross section.

The description now reverts to FIG. 4. Analogous to the clamping arm 340, the clamping arm 330 has an elongated limb that lies within the receiving and turning chamber 312 and features an angled holding arm 333. The holding arm 333 has an inwardly directed section that is provided with beveled guide surfaces 338 and 339 on the end face. A supporting plate 370 is mounted on the underside of the clamping arm 330. Bores 335 in the angled holding arm 333 can be used for this purpose. A bore 323 in the guiding and holding element 320 is aligned with the bore 346 in the clamping arm 340 in order to receive the retaining bolt 353. Similarly, a bore 313 in the guiding and holding element 310 is aligned with a corresponding bore in the clamping arm 330 in order to receive a retaining bolt 352. A tension spring 351 is held by the retaining bolts 353 and 352 and presses the angled holding arms 333 and 343 against one another in the idle state of the system 1. The tension spring 351 and the retaining bolts 353 and 352 therefore form a mechanical clamping device 350. A bore 324 in the guiding and holding element 320 is aligned with the bore 347 in the clamping arm 340 in order to receive a pivot pin. A bore 314 in the guiding and holding element 310 is similarly aligned with a bore in the limb of the clamping arm 330 in order to receive an additional pivot pin.

As mentioned above, the beveled guide surfaces 338 and 348 form a wedge-shaped receptacle when the clamping arms 330 and 340 are pressed together, wherein the wedge-shaped tip of the actuating element 195 of the square ram 190 shown in FIG. 6 can engage in the wedge-shaped receptacle.

At this point, it should be noted that the glass stopper 10 has an essentially T-shaped cross section, e.g., as schematically illustrated in FIG. 2. According to this figure, the glass stopper has a circular head part 11, the diameter of which is greater than that of the shaft 12. The shaft 12 preferably is conically tapered in the direction extending away from the head part 11.

The function of the system 1 is described in detail below.

It is assumed that glass stoppers 10 are supplied from supply device 30, via supply rail 120 and connecting element 130, to a glass stopper holding device 300 that is not illustrated in detail in FIG. 4. The supply of the glass stoppers 10 is realized such that the shaft 12 of the glass stopper 10 points in the direction of the bottle 20. The head 11 of a glass stopper 10 is transferred via connecting element 130 to the guide rails 311 and 321 of the respective guiding and holding element 310 or 320 and pushed against the angled holding arms 343 and 333 of the clamping arms 340 and 330. The head 11 of the glass stopper 10 is then held on supporting plates 360 and 370 fixed underneath the clamping arms 330 and 340. The lifting cylinder 240 is activated as soon as an arriving bottle is detected by the detectors 250 and 251. Subsequently, the holding and positioning element 210 is displaced in the direction of the bottle 20 and takes hold of the bottle 20. It should be noted that the supply device 60 does not have to be stopped while a bottle 20 is sealed. The bottle neck holding arms 410 and 420 are simultaneously driven by a not-shown lifting cylinder device in order to take hold of the bottle neck of the bottle 20 to be sealed. Subsequently, the ram 190 is displaced in the direction of the bottle 20 to be sealed by means of the lifting cylinder 305 such that the actuating element 195 penetrates between and opens the clamping arms 330 and 340. The head 11 of the glass stopper 10 is subsequently released and inserted into the bottle neck by means of the ram 190.

In order to prevent damage to the glass stopper 10 during the supply and sealing process, the supply rails 120, the inner surfaces of the clamping arms 330 and 340 as well as the end face of the ram 180 or 190 are coated with a soft, elastic material.

The invention for the first time makes it possible to seal bottles with rigid, non-elastic closures, particularly glass stoppers. In order to seal bottles with glass stoppers, it is necessary to precisely position and hold the bottles to be sealed underneath the glass stopper. This can be achieved with the inventive system 1.

### LIST OF REFERENCE SYMBOLS

1 System for sealing bottles
10 Glass stopper
11 Head
12 Shaft
20 Bottle
30 Glass stopper supply device
40 Supply baffle
50 Rectangular tube
60 Bottle supply device
62 Conveyor belt
63, 64 Guide rails
70 Upper supporting plate
80 Height-adjustable lifting device
90 Central supporting plate
100 Bottom plate
110 Assembly
111 Supporting device
112 Base plate
113 Holding plates
114 Holding plates
120 Supply rail
130 Connecting element
132 Connecting plate
134 Guide rail
140 Holding clip
150 Connecting plate
180 Ram with round cross section
193 Groove for receiving the actuating element
190 Ram with rectangular cross section
191-194 Centering tabs
195 Actuating element
200 Bottle holding and positioning device
201 Bores
202 Bores
203 Bores
205 Upper L-shaped supporting plate
207 Lower L-shaped supporting plate
209 Holding plate
210 Holding and positioning element
211 Upper profiled holding arm
212 Lower profiled holding arm
213 Base plate
220 Concave inner surface of the holding arms
230 Piston
240 Lifting cylinder
250 Detector
251 Detector
300 Glass stopper holding device
305 Lifting cylinder
310 Guiding and holding element
311 Guide rail for the head of a glass stopper
312 Receiving and turning chamber
313 Bore for accommodating a retaining bolt
314 Bore for accommodating a pivot pin
315 Bores
320 Guiding and holding element
321 Guide rail for the head of a glass stopper
322 Receiving end turning chamber
323 Bore for receiving a retaining bolt
324 Bore for receiving a pivot pin
325 Bores
330 Clamping arm
333 Angled holding arm
335 Bores
338 Sloped guide surfaces
339 Sloped guide surfaces
340 Clamping arm
341 Limb
342 Connecting web
343 Angled holding arm
344 Rounded inner surface
345 Bores
346 Bore for receiving a retaining bolt
347 Bore for receiving a pivot pin
348 Sloped guide surfaces
349 Sloped guide surfaces
350 Mechanical tensioning device
351 Tension spring
352 Retaining bolt
353 Retaining bolt
360 Supporting plate
370 Supporting plate
380 Angled holding element
381 Bores
382 Bores
390 Guide element
400 Holding device for holding a bottle neck
410 Profiled holding arm
420 Profiled holding arm
500 Disinfection chamber
510 Supply line for supplying a disinfectant
520 Line for connecting a suction device

1. An assembly (110) for sealing containers (20) with rigid closures (10) that are adapted to the containers (20), comprising:
one controllable ram (180, 190) for joining at least one container (20) and at least one rigid closure (10),
a holding device (300) for holding the at least one rigid closure (10), wherein the holding device (300) has a shape that is at least partially adapted to the shape of the at least one rigid closure (10) so as to hold the rigid closure (10) in a predetermined position, and
at least one clamping arm (330, 340), wherein the at least one clamping arm (330, 340) features at least one supporting surface (360, 370), on which the at least one rigid closure (10) lies while it is held by the holding device (300).

2. The assembly (110) according to claim 1, wherein the holding device (300) is realized in such a way that the at least one rigid closure (10) is at least sectionally guided while it is joined with the container.

3. (canceled)

4. The assembly (110) according to claim 1, wherein the holding device (300) comprises at least one guiding element (310, 320), on which the at least one clamping arm (330, 340) is mounted.

5. The assembly (110) according to claim 1, wherein at least a partial area (344) on the inner side of the at least one clamping arm (340) is rounded in order to hold rigid closures (10) that have an at least partially cylindrical shape.

6. The assembly (110) according to claim 1, wherein the holding device (300) features at least one clamping device (350) for clamping the at least one clamping arm (330, 340).

7. The assembly (110) according to claim 6, wherein the at least one clamping device (350) is realized in at least one of the following ways: mechanically, electrically and pneumatically.

8. (canceled)

9. The assembly (110) according to claim 1, wherein the supporting surface (360, 370) is formed by at least one plate mounted on the at least one clamping arm (330, 340).

10. The assembly (110) according to claim 1, wherein the holding device (300) comprises:
a first and a second guiding element (310, 320), between which the at least one rigid closure (10) is horizontally guided,
a first and a second clamping arm (330, 340) that are respectively arranged in a movable fashion on the first and second guiding elements (310, 320), and
a clamping device (350) that prestresses the first and second clamping arms (330, 340) relative to one another.

11. The assembly (110) according to claim 1, wherein the ram (180, 190) is realized in such a way that the at least one clamping arm (330, 340) is displaced by the ram (180, 190) during the joining of the at least one container (20) and the least one rigid closure (10).

12. The assembly (110) according to claim 11, wherein an actuating element (195), that has a wedge-shaped lower end and serves for opening the clamping arms (330, 340) and for centering the clamping arms relative to the position of the container opening, is laterally mounted on the ram (180, 190).

13. The assembly (110) according to claim 1, comprising a guide rail (390) for guiding the ram (190), wherein the cross section of the ram (190) perpendicular to its moving direction is essentially polygonal and the guide rail (390) is adapted to this shape.

14. The assembly (110) according to claim 1, wherein the end face of the ram (190) features at least three centering tabs (191-194) for positioning and fixing the at least one rigid closure (10).

15. The assembly (110) according to claim 1, wherein the ram (180, 190) has a profiled end face (182).

16. The assembly (110) according to claim 15, wherein the profiled end face (182) of the ram (180, 190) is realized complementary to the end face of the at least one rigid closure (10).

17. The assembly (110) according to claim 1, wherein the holding device (300) is at least partially realized in a funnel-shaped fashion.

18. The assembly (110) according to claim 17, wherein the holding device (300) is at least sectionally realized elastically.

19. The assembly (110) according to claim 1, furthermore comprising at least one positioning device (200, 400) for fixing a container (20).

20. The assembly (110) according to claim 19, wherein the positioning device (200, 400) comprises at least one of (i) at least one optical sensor (250, 251) and (ii) a mechanical roller switch with lever flag, in order to detect a container (20).

21. The assembly (110) according to claim 19, wherein the positioning device (200, 400) is designed for fixing a container (20) during the continuous operation of the supply device (60).

22. The assembly (110) according to claim 19, wherein a first positioning device (200) features a controllable pressing element for being pressed against an abutment.

23. The assembly (110) according to claim 19, wherein a second positioning device (400) features two controllable grippers (410, 420) that can be moved toward one another in order to fix a container (20), in the region of the bottle neck.

24. The assembly (110) according to claim 23, wherein the side of the grippers (410, 420) that engages on the container (20) features one of (i) a trapezoidal recess and (ii) a wedge-shaped recess.

25. A system (1) for sealing containers (20) by means of rigid closures (10) that are adapted to the containers (20), comprising at least:
one assembly,
a device (60) for supplying at least one container (20) and
a device (30, 40, 120, 130) for supplying at least one rigid closure (10);
wherein said assembly comprises at least:
one controllable ram (180, 190) for joining the at least one container (20) and the at least one rigid closure (10),
a holding device (300) for holding the at least one rigid closure (10), wherein the holding device (300) has a shape that is at least partially adapted to the shape of the at least one rigid closure (10) so as to hold the rigid closure (10) in a predetermined position, and
at least one clamping arm (330, 340), wherein the at least one clamping arm (330, 340) features at least one supporting surface (360, 370), on which the at least one rigid closure (10) lies while it is held by the holding device (300).

26. The system (1) according to claim 25, wherein the device (30, 40, 120, 130) for supplying at least one rigid closure (10) comprises a workpiece supply device (30) for delivering rigid closures (10) in a correctly positioned fashion.

27. The system (1) according to claim 26, wherein the workpiece supply device (30) features one of (i) a swing feeder and (ii) at least one slide valve.

28. The system (1) according to claim 25, furthermore comprising a supply baffle (40) for transferring the at least one rigid closure (10) from a first orientation to a second orientation.

29. The system (1) according to claim 25, furthermore comprising a supply rail (120) that is at least partially sloped downward in the direction of the holding device (300).

30. The system (1) according to claim 29, wherein the downward slope and the horizontal line form an angle between 30° and 60°.

31. The system (1) according to claim 25, furthermore comprising a disinfection device (500) for disinfecting the at least one rigid closure (10).

32. The system (1) according to claim 25, wherein at least one of the following features a protective coating for protecting the at least one rigid closure (10) from being damaged due to contact with the partial area of a surface: at least a partial area of a surface of a workpiece supply device (30), a supply baffle (40), a supply rail (120, 130), a guide element (310, 320), a clamping arm (330, 340), and a ram (180, 190).
